(19) United States
(12) Patent Application Publication
(10) Pub. No.: US 2005/0145693 A1
(43) Pub. Date: Jul. 7, 2005

(54) Self-service product detection station

(75) Inventors: Guenter Baitz, Berlin (DE); Heinz Sommer, Wusterwitz (DE)

Correspondence Address: Richard R Michaud;McCormick Paulding & Huber, City Place II, 185 Asylum Street, Hartford, CT, 06103, US

(73) Assignee: WINCOR NIXDORF INTERNATION GMBH, PADERBORN (DE)

(21) Appl. No.: 10/503,510

(22) PCT Filed: Feb. 12, 2003
(86) PCT No.: PCT/DE03/00396

(30) Foreign Application Priority Data
Feb. 22, 2002 (DE) 102 07 568.9

(51) Int. Cl. G06K 15/00

(52) U.S. Cl. 235/383

(57) ABSTRACT

The invention relates to the reliable and fast deferred detection of unscanned articles at self-service product detection stations. For this purpose, a camera is mounted on the weighing scale, so that articles which have not been scanned can be registered. The camera is activated when the weight indication of the weighing scale changes without an article having been scanned. The camera consequently registers the article last placed on the weighing scale and transmits this image to the display of an operator, who is informed about the article not scanned in and can correspondingly ask the customer to detect retroactively the article that has inadvertently not been detected.

### CROSS-REFERENCE TO RELATED APPLICATIONS

This application is entitled to the benefit of and incorporates by reference essential subject matter disclosed in International Application No. PCT/DE03/00396 filed on Feb. 12, 2003 and German Patent Application No. 10207568.9 filed on Feb. 22, 2002.

### FIELD OF THE INVENTION

The invention relates to a self-service product detection station and is generally directed to an apparatus for detecting unscanned items.

### BACKGROUND OF THE INVENTION

There are various known self-service product detection stations, in which the products selected by the customer are detected and a bill is automatically produced. For this purpose, the customer brings the products, which have generally been deposited in a shopping cart, to a product detection station and makes them undergo a scanning operation, in which normally the barcode located on the products is scanned by means of a barcode reader. After that, the products are placed in a depository, which may also be a further shopping cart or a shopping bag, which is coupled to a balance. When the products are identified by scanning of the barcode, the product price and the type of product are determined. If the products are products that are to be weighed, such as fruit and vegetables, they can be weighed, it being possible for the type of product to be selected in advance, for example on a touchscreen, in order to determine the correct price for these products. When the customer then places the products in the depository, they are once again weighed and the weighing result is compared with the weight that is intended for this type of product or with the weight that has been determined in the weight detection of individual products to be weighed. If the values obtained in the comparison coincide, incorrect evaluation and attempted fraud can be ruled out.

If, however, the customer actually has not scanned an article, it is often very difficult to find out which article is concerned, since a definitive determination of the articles is not possible by means of the weight. For example, many foods are offered as 500 g packages.

It is therefore the object of the invention to permit reliable and fast deferred detection of articles not scanned in.

### SUMMARY OF THE INVENTION

This object is achieved by the features specified in claim 1. By mounting a camera over the weighing scale, the articles which have not been scanned are detected. The camera is activated if the weight indication of the weighing scale changes without an article having been scanned. The camera consequently detects the last article placed on the weighing scale and transmits this image to the display of an operator, who is consequently informed of the article not scanned in and can correspondingly ask the customer to detect retroactively the article that has inadvertently not been detected.

### BRIEF DESCRIPTION OF THE DRAWINGS

Further details and advantages of the invention emerge from the description which follows and the drawing, in which:

FIG. 1 shows a perspective view of a self-service product detection station according to the invention.

### DETAILED DESCRIPTION OF THE PREFERRED EMBODIMENTS

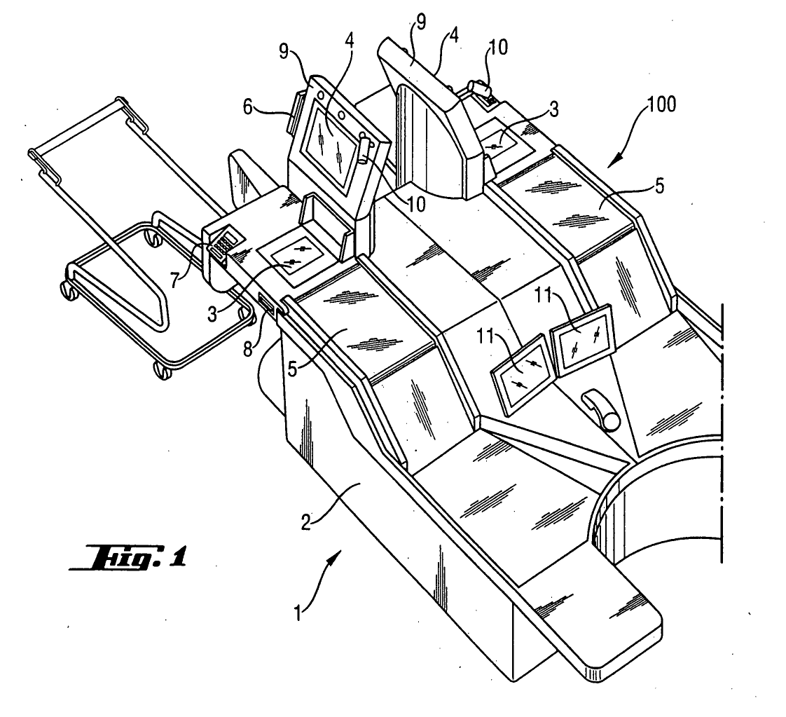

Represented in FIG. 1 is a self-service product detection station 1 comprising a support housing 2, which is equipped with a barcode reader 3 with an integrated balance for the detection of loose articles such as fruit and vegetables, a display 4 for the input of article descriptions and display of customer information such as the price, the weight, the type of product, etc., and also a weighing scale 5. Furthermore, a swipe card reader 6 for credit cards and ec cards, a pin input keypad 7 and a card input reader 8 are advantageously provided. A customer generally brings the products to the self-service product detection station 1 altogether in a shopping cart, takes the products out of the cart and scans them by means of the barcode reader 3, which detects a barcode provided on the products. Some other identification such as three-dimensional codes and transponders are also possible within the scope of the invention. If fruit or vegetables are concerned, the customer selects the respective kind of fruit or vegetable on the keypad and then the price is determined on the basis of the weight registered by means of the integrated balance. The customer then places the products on the second weighing scale, on which the weight of all the products already detected are summated. If the customer has scanned in all the products and the weight of the products placed on the weighing scale still coincides with the weight obtained from the product scanning on the basis of the weight assigned to the respective article, the customer pushes a button at the end of the procedure to signal that all the products have now been detected and consequently thereby initiates a payment operation. The total price is displayed on the display and the customer can then pay the bill by means of a credit card or his ec card.

If, however, the customer has inadvertently or deliberately not scanned in an article, the weight detected by the weighing scale 5 deviates from the weight which would be obtained on the basis of the product scanning. On account of this difference in weight, the video camera 10 advantageously fastened to the display housing 9 is activated, registers an image of the articles resting on the weighing scale and passes this image on to a second display 11. This display 12 is observed by an operator, who can on the basis of the image instruct the customer to detect retroactively the article last placed on the weighing scale 5. Since the article is registered on the basis of the image, the operator can demonstrate to the customer which article the customer has overlooked during the scanning-in. The registering of an image avoids having to identify the article on the basis of its weight alone. Since articles with the same weight could have very different prices, the customer could previously have retroactively scanned in an article which although identical to the unscanned article with respect to its weight is not identical with respect to the price.

Preferably two self-service product detection stations 1, 100 are combined, so that an operator can jointly oversee two self-service product detection stations 1, 100. In the case of such an arrangement, the display 12 may be duplicated, or a split screen is chosen, part of the screen respectively being available for a self-service product detection station. This operator advantageously also assists the customer in packing up the products. It is also possible within the scope of the invention to combine further self-service product detection stations to form a self-service center,which is respectively supervised by an operator. The display 11 may in this case be directly connected to the housing of a self-service product detection station, or it may be formed as a portable device which the operator carries or is attached to his or her clothing. In this case, the display is preferably miniaturized.

1. A self-service product detection station with a reading device for detecting the products, a first balance for weighing loose items, a display for the display and input of information, a second weighing scale and a card reader for payment for the products, characterized in that a video camera (10) for registering the products on the weighing scale (5) is provided and an image registered by the camera (10) is passed on to a display (11).

2. The self-service product detection station as claimed in claim 1, characterized in that two self-service product detection stations (1, 100) are combined and can be overseen together by means of the display (11).

3. The self-service product detection station as claimed in claim 1 or 2, characterized in that the display (11) is portable.
